(19) United States
(12) Patent Application Publication
(10) Pub. No.: US 2013/0247385 A1
(43) Pub. Date: Sep. 26, 2013

(54) COMPOUND WIRE ROPE CUTTER

(71) Applicant: Philip J. Pisczak, Chagrin Falls, OH (US)

(72) Inventor: Philip J. Pisczak, Chagrin Falls, OH (US)

(73) Assignee: The National Telephone Supply Company, Cleveland, OH (US)

(21) Appl. No.: 13/849,093

(22) Filed: Mar. 22, 2013

Related U.S. Application Data
(60) Provisional application No. 61/614,702, filed on Mar. 23, 2012.

(51) Int. Cl. B23D 29/00

(52) U.S. Cl. CPC B23D 29/002
USPC 30/252

(57) ABSTRACT

A compound wire rope cutter has a first handle and a second handle; a first lever and a second lever; and a first cutting jaw and a second cutting jaw. The first cutting jaw is formed at a distal end of the first lever. A second cutting jaw is formed at a distal end of the second lever. A first pivot pivotally connects the first handle and the second handle. A second pivot pivotally connects the first lever to the first handle. A third pivot pivotally connects the second lever to the second handle. A fourth pivot pivotally connects the first lever to the second lever. A first mechanical advantage is defined as a pivot lever length divided by a pivot jaw length, and a second mechanical advantage is defined as a handle length divided by a pivot handle length. A compound mechanical advantage is obtained by multiplying the first and second mechanical advantages together.

### CLAIM OF PRIORITY

This application claims priority from Provisional Application Ser. No. 61/614,702, filed on Mar. 23, 2012, the entirety of which is hereby incorporated by reference.

### BACKGROUND OF THE DISCLOSURE

This disclosure relates to wire rope cutters. More particularly, this disclosure relates to wire rope cutters with a compound mechanical advantage.

Existing cutting tools which may use a mechanical advantage are sometimes used in the arbor industry for cutting small diameter wire rope. Some existing cutters supposedly utilizing a compound mechanical advantage so that the cutting jaws are better enabled to open further. The opposite is actually the case. The handles must be opened further than with a single stage cutter in order to open an equivalent amount to a single stage cutter.

An example of an existing compound lever cutter is shown in U.S. Pat. No. 92,092. However, the cutter mechanism in U.S. Pat. No. 92,202 is used in the arbor industry and does not save space or overall length.

Existing cutting tools utilize a fulcrum method to generate additional force for the purpose of cutting through wire rope. (See FIG. 1). This results in a mechanical advantage which is typically defined as the ratio of the output force created by a mechanism divided by the applied input force. However, due to the length of a handle from a pivot compared to the length of the cutting jaw, a single mechanical advantage is developed. The mechanical advantage (MA) is defined as the pivot handle length divided by the pivot jaw length or:

MA=Pivot Handle Length/Pivot Jaw Length

Thus, there exists a need for a wire rope cutter which has a compound mechanical advantage. There also exists a need for a compound cutter which is nested and has a reduced overall length.

Other benefits and aspects of the disclosure will become apparent upon a reading and understanding of the following detailed description.

### SUMMARY OF THE DISCLOSURE

In accordance with one aspect of the disclosure, a wire rope cutter has a first handle and a second handle; a first lever and a second lever; a first cutting jaw and a second cutting jaw; wherein the first cutting jaw is formed at a distal end of said first lever; said second cutting jaw is formed at a distal end of the second lever; a first pivot for pivotally connecting the first handle and the second handle; a second pivot for pivoting connecting the first lever to the first handle; a third pivot for pivotally connecting the second lever to the second handle; and a fourth pivot for pivotally connecting the first lever to the second lever.

In accordance with another aspect of the disclosure, a compound wire rope cutter assembly has a first handle and a second handle having a first pivot connecting the first and second handles; a first cutting jaw half and a second cutting jaw half, wherein the first cutting jaw half is connected to the first handle via a second pivot; wherein the second cutting jaw half is connected to the second handle via a third pivot; and wherein the first cutting jaw half and the second cutting jaw half are connected by a fourth pivot; wherein a compound mechanical advantage is defined by a first mechanical advantage defined by a pivot lever length and a pivot jaw length, and a second mechanical advantage defined by a handle length and a pivot handle length.

Another aspect of the disclosure is a compound mechanical advantage formed by a first mechanical advantage and a second mechanical advantage.

Other aspects of the disclosure will become apparent upon a reading and understanding of the following detailed description.

### BRIEF DESCRIPTION OF THE DRAWINGS

FIG. 1 illustrates an existing cutter which uses a fulcrum method to generate additional force;

FIG. 2 illustrates a perspective view of a compound wire rope cutter in accordance with a preferred embodiment of the present disclosure;

FIG. 3 illustrates a top plan view of the compound wire rope cutter of FIG. 2;

FIG. 4 illustrates a partial top plan view of the cutter in an opened position;

FIG. 5 illustrates a perspective view of the cutter of FIG. 2 cutting a wire rope;

FIG. 6 illustrates a top plan view of the cutter of FIG. 2 in a fully opened position;

FIG. 7 illustrates an exploded perspective view of the cutter of FIG. 2;

FIG. 8 illustrates a top plan view of a forward toggle cutter in accordance with another aspect of the disclosure;

FIG. 9 illustrates a chart illustrating a mechanical advantage between an existing cutter, a reverse toggle and a forward toggle cutter;

FIG. 10 illustrates a chart showing maximum handle forces of a cutter in accordance with the present disclosure versus an existing cutter;

FIG. 11 illustrates a perspective view of a cutter jaw with a grease port option in accordance with another aspect of the disclosure; and

FIG. 12 illustrates a transparent perspective view of the cutter jaw of FIG. 11.

### DETAILED DESCRIPTION OF THE DISCLOSURE

The present disclosure relates to wire rope cutters. More particularly, it relates to a wire rope cutter having a compound mechanical advantage.

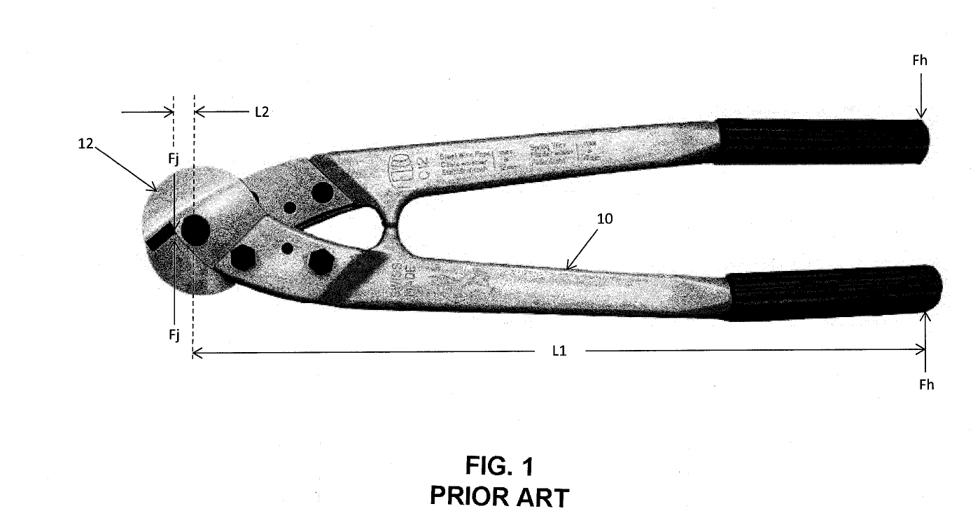

Existing cutter tools typically use a single fulcrum method to generate additional force for the purpose of cutting through wire rope. Referring to FIG. 1, an existing cutter tool has a pivot handle 10 which has a pivot handle length (L1) of e.g., about 18.25 inches. A jaw 12 has a pivot jaw length (L2) of e.g., about 0.562 inches. The force applied at the jaw is shown as Fj and the force applied at the handle is shown as Fh. The force is applied as pounds force. Due to the length of the handle from the pivot when compared to the length of the cutting jaw to the pivot a mechanical advantage (MA) is developed as the pivot handle length (L1) divided by the pivot jaw length (L2), or:

$$MA = \frac{L 1}{L 2}$$

$$or$$

$$32.44 = \frac{18.25}{0.562}$$

Thus the mechanical advantage is 32.44.

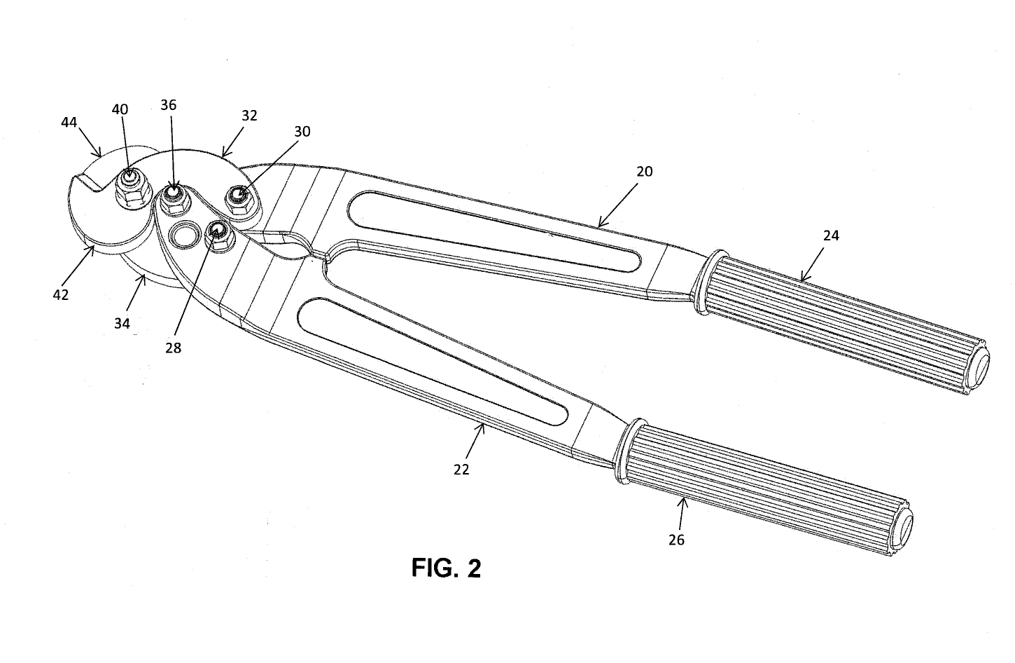

Referring now to FIGS. 2-7, a compound wire rope cutter in accordance with a preferred embodiment of the disclosure is shown. A compound mechanical advantage is defined as a mechanical advantage combined with or superimposed onto another mechanical advantage. The force applied at the jaw is shown as Fj and the force applied at the levers is shown as Fl and the force applied at the handle is shown as Fh. The force is applied as pounds force.

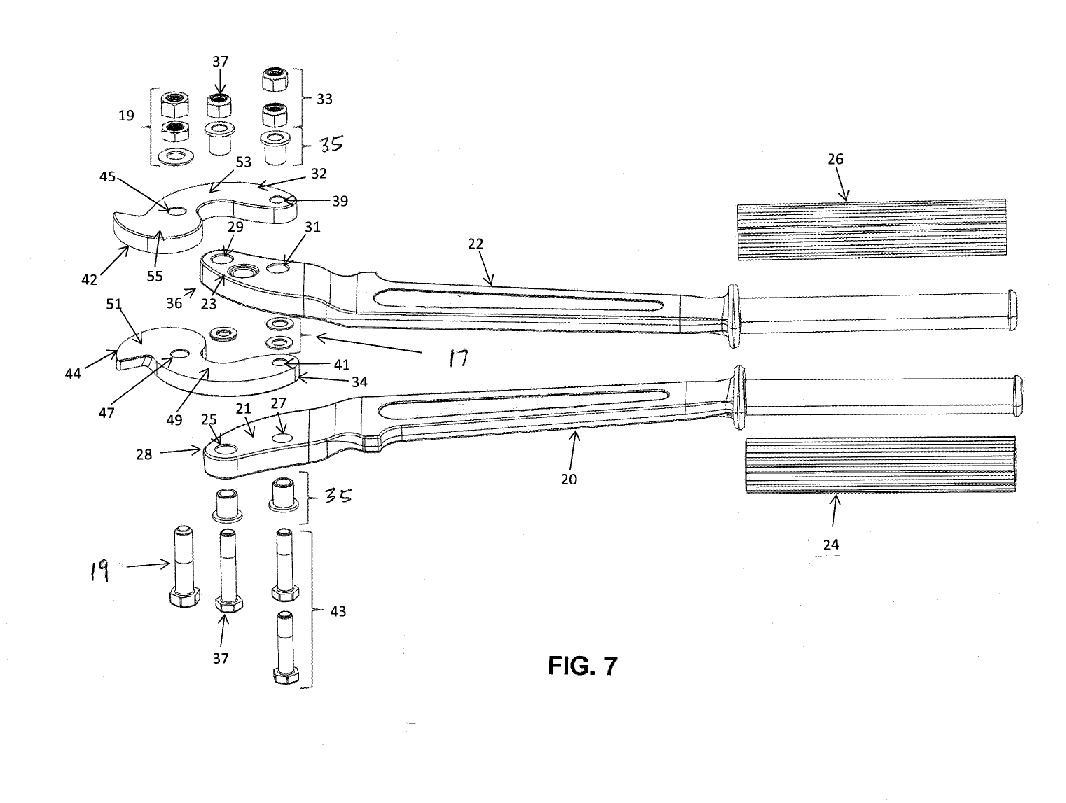

Referring to FIG. 2, the cutter in accordance with one aspect of the disclosure has handles 20, 22 which are preferably symmetrical and preferably made of aluminum and are corrosion resistant. Each handle has an angled or curved portion 21, 23 (FIG. 7) which are angled in opposite directions to which the levers 32, 34 are pivotally mounted. Ends of the curved portions 21, 23 curve each other in an assembled configuration.

Referring to FIG. 7, portion 21 a pair of openings 25, 27, wherein opening 25 aligns with opening 29 of portion 23 to form handle pivot 36. A bolt, flange washer and nut assembly 37 is used to pivotably retain portion 21 to portion 23 via openings 25, 29. Opening 27 of portion 21 aligns with opening 39 of lever 32 to form lever pivot 30. Nut 33, flange washer 35, bolt 43 and washer 17 retains portion 21 to pivot 32 to form lever pivot 30.

Opening 31 of portion 23 aligns with opening 41 of lever 34 to form lever pivot 28. Bolt 43, nut 33 and flange washer assembly 35, 17 pivotably retains portion 31 to lever 34.

Opening 45 of jaw 42 and opening 47 of jaw 44 together form pivot 40 for cutting jaws 42, 44. Bolt, nut and washer assembly 19 pivotably retain jaw 42 to jaw 44 to form jaw pivot 40.

Lever 34 has a first curved portion 49 and a second curved portion 51 which form the jaw 44. Curved portion 51 is curved in an opposite direction to a curved portion 49. Similarly, lever 32 has a first curved portion 53 and a second curved portion 55 which forms jaw 42. Portion 53 curves in an opposite direction to portion 55.

Due to lower handle forces, lighter weight material such as aluminum can be used. The handles can have grips 24, 26 formed of a suitable grippable material such as an extruded Santoprene™. However, other materials are also contemplated by the disclosure.

There are two lever pivots 28, 30 for levers 32, 34 and handle pivot 36 for handles 20, 22. A jaw pivot 40 is used for pivoting cutting jaws 42, 44. Cutting jaws 42, 44 are symmetrical and are preferably made of a steel alloy. The pivots 28, 30, 36, 40 form the nested compound force multiplier section of the cutter.

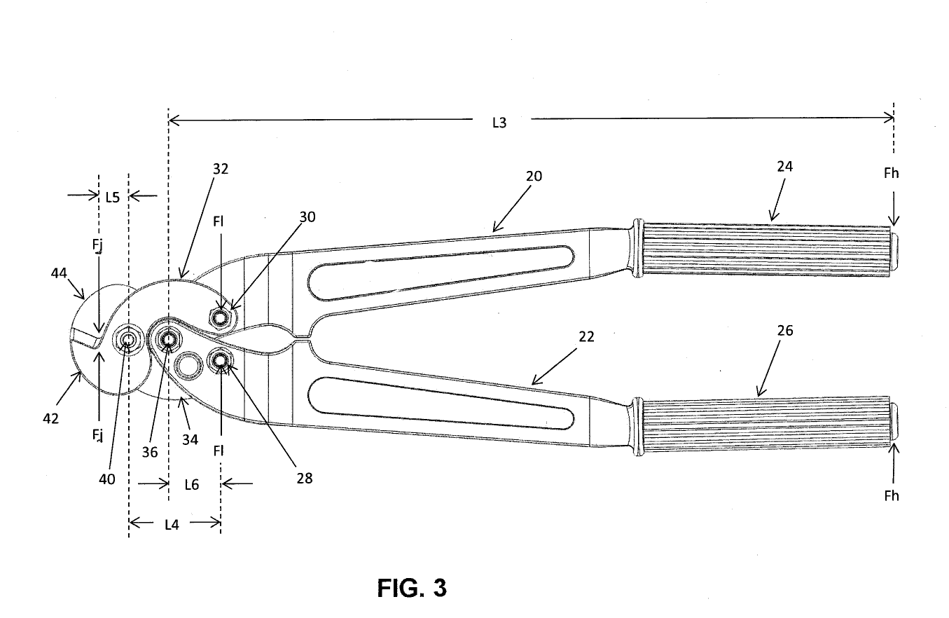

FIGS. 3-7 and the discussion below illustrate approximate dimensions for the various lengths. These dimensions are provided for illustrative purposes and show one example of the calculation of a mechanical advantage. Other sizes, configurations and dimensions are contemplated by the disclosure.

Referring now to FIG. 3, the handle length L3 can be about 16.925 inches from an end of the handle (where force Fh is applied) to the handle pivot 36. The pivot lever length L4, i.e., the distance between jaw pivot 40 and lever pivots 28, 30 (where force Fl is applied) is about 2.144 inches. The pivot jaw length L5, i.e., the distance between jaw pivot 40 and an inner edge of the jaw (where force Fj is applied) is about 0.622 inches. The pivot handle length L6, i.e., the distance between handle pivot 36 and lever pivots 28, 30 is about 1.200 inches. Thus, the first mechanical advantage MA1 is calculated as follows:

MA1 is the pivot lever length L4 divided by the pivot jaw length L5, or:

$$MA 1 = \frac{L 4}{L 5}$$

$$or$$

$$3.45 = \frac{2.144}{0.622}$$

Thus, the first mechanical advantage MA1 is approximately 3.45. The second mechanical advantage MA2 is calculated as the handle length L3 divided by the pivot handle length L6, or:

$$MA 2 = \frac{L 3}{L 6}$$

$$or$$

$$14.10 = \frac{16.925}{1.200}$$

Thus, the second mechanical advantage MA2 is approximately 14.10. The overall compound mechanical advantage MAC, at this particular angle of handle opening, is MA1 multiplied by MA2 or MA1×MA2 or 3.45×14.10=48.66. Thus, compound mechanical advantage MAC is approximately 48.66.

Thus, the advantage of the present disclosure when compared to an existing tool is therefore 48.66/32.44=1.5. In other words, the present disclosure tool requires less force, or 1/1.5 or approximately two-thirds or about 0.67 times the amount of force required as an existing tool to cut a wire rope; again, at this particular angle of handle opening.

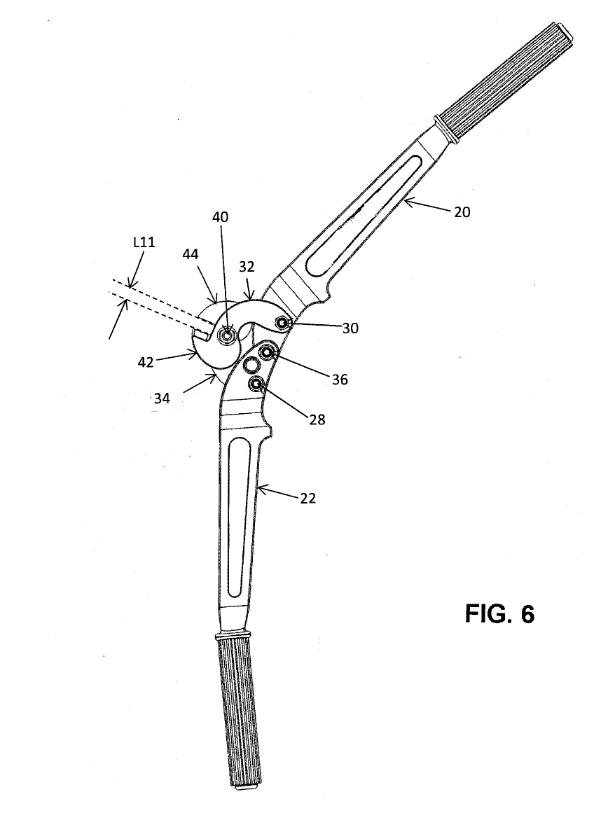

The compound mechanical advantage of the present disclosure is different when the tool is opened to allow the insertion of the largest diameter wire rope (i.e., about 10mm). That is, the opening L11 between the jaws is about 10 mm (see FIG. 6).

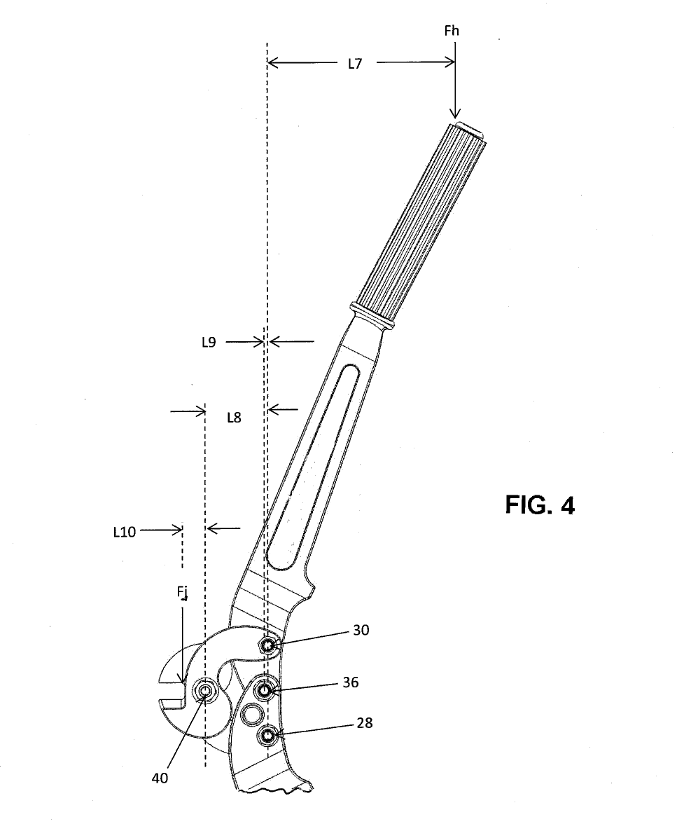

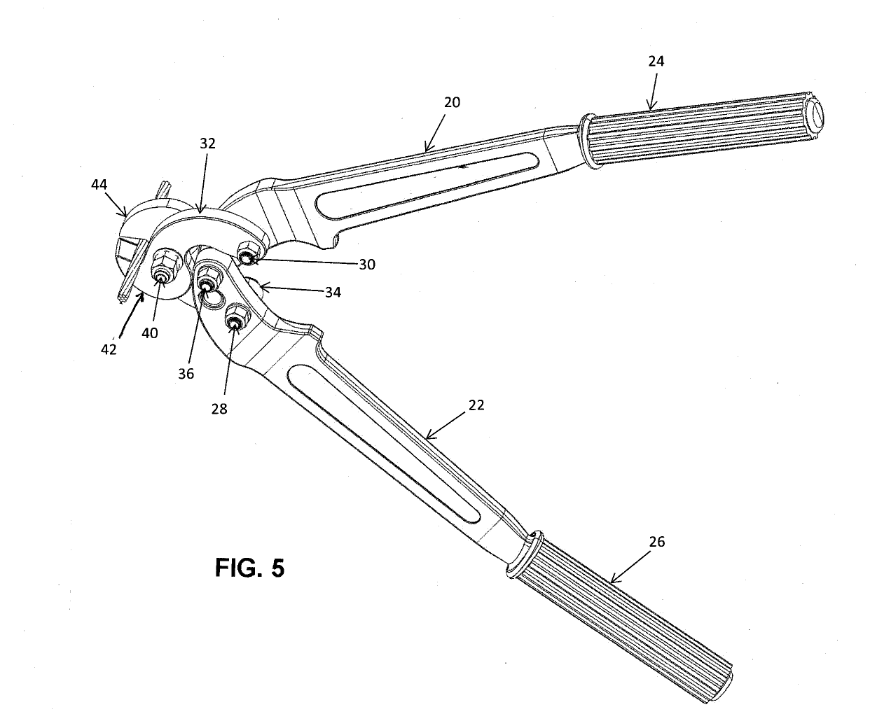

Referring now to FIG. 4, the handle length L7, i.e., the distance from an end of the handle (where force Fh is applied) to the handle pivot 36 is about 5.578 inches. The pivot lever length L8, i.e., the distance between lever pivots 28, 30 and jaw pivot 40 is about 1.780 inches. The pivot handle length L9, i.e., the distance between lever pivots 28, 30 l and pivot 36 is about 0.099 inches. The pivot jaw length L10, i.e., the distance between pivot 40 and the inside edge of a jaw is about 0.664 inches. The relationship between the first and second mechanical advantages is the same as before, but the torque lengths are different as shown in FIG. 5. Specifically, a first mechanical advantage is defined as the pivot lever length L8 divided by the pivot jaw length L10, or:

$$MA 3 = \frac{L 8}{L 10}$$

$$or$$

$$2.681 = \frac{1.780}{0.664}$$

and
The second mechanical advantage is defined as the handle length L7 divided by the pivot handle length L9, or:

$$MA 4 = \frac{L 7}{L 9}$$

$$or$$

$$56.343 = \frac{5.578}{0.099}$$

Thus, overall compound mechanical advantage MAC2 in this case is MA3 multiplied by MA4 or MA3×MA4=2.681×56.343=151.06.

That is, the compound mechanical advantage MAC2 is approximately 151.06/48.66=3.1 times greater than when the tool is closed as in the previous case.

The tradeoff between the closed and open tool is the amount of jaw closure relative to the angle movement of the handles. For example, when the tool is opened the amount of jaw closure is proportionately smaller when the handles proceed to close.

This is significant since the force required to initiate the cutting is greatest for the largest diameter wire rope. From an ergonomic point of view the handles are at their further apart configuration.

Therefore, the compound mechanical advantage is greatest when the wire rope is of the largest diameter. This is a distinct advantage over the single mechanical advantage of many existing tools and the forward toggle design as used by others.

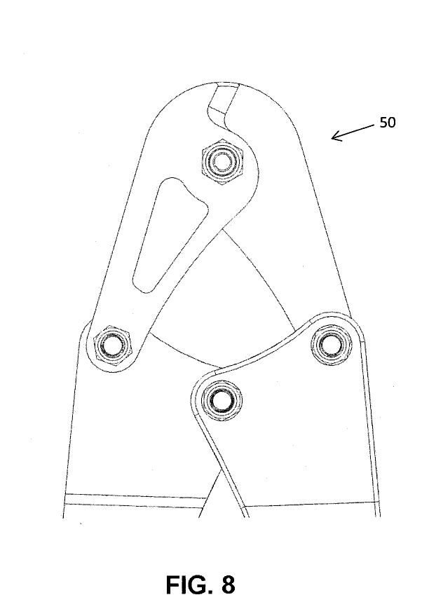

Referring now to FIG. 8, a “forward toggle” or jaw lever 50 which operates in an opposite fashion to a reverse toggle cutter is shown. The greatest compound mechanical advantage is when the handles are closed. At this point the cut is complete and the benefit of a high mechanical advantage is not utilized.

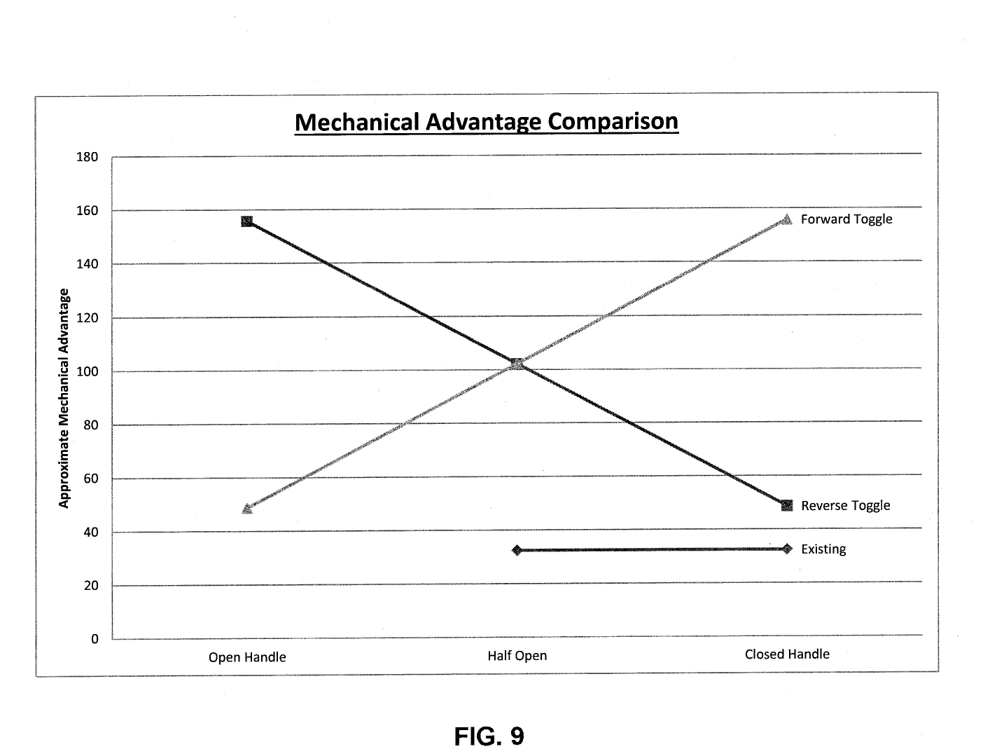

A chart illustrated in FIG. 9 shows an approximate relationship between the three (3) different cutters, i.e., a forward toggle cutter, a reverse toggle cutter and an existing single mechanical advantage cutter.

While the theoretical static loading of these hand tools yield mechanical advantage factors, the actual kinematics of the cutting process is more involved. For purposes of calculations, it is assumed, for sake of convenience, that the blade shapes and swing motion when cutting are the same, when in fact they vary. Additionally the wire rope, how much it flattens during cutting and other kinematic factors as to where in the compound mechanism cutting occurs will vary from theoretical values.

Ultimately, the advantage of the tool of the present disclosure tool is that it yields a lower required handle force to cut the same diameter and type of wire rope.

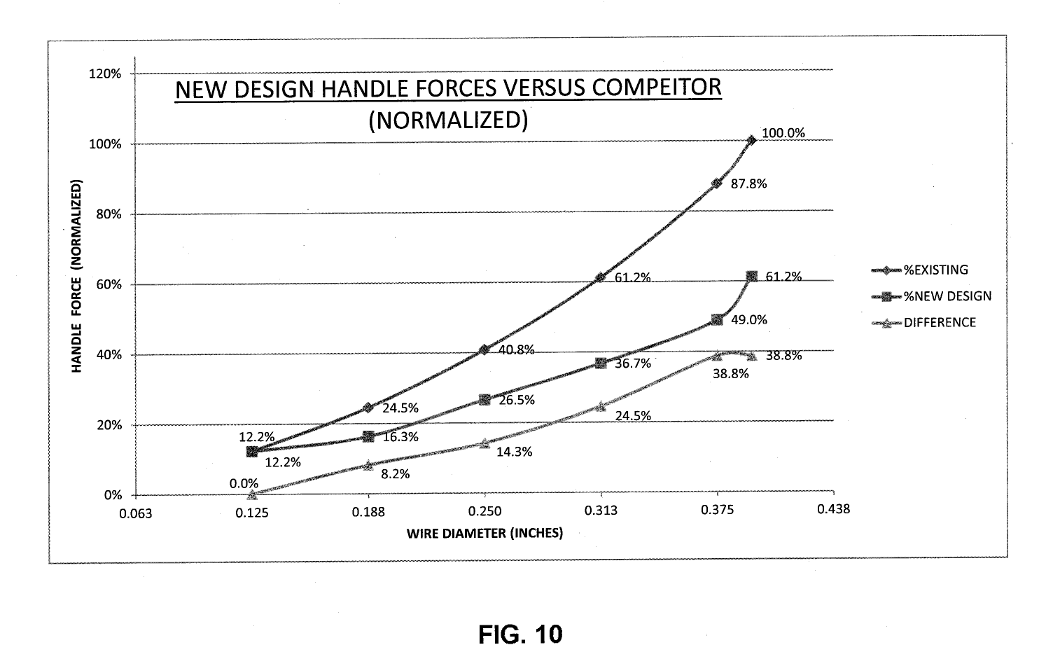

Referring now to FIG. 10, a chart is shown illustrating the maximum measured handle forces the cutter of the present disclosure versus an existing cutter. The results were then normalized to the highest handle cutting force required with the existing tools. It is apparent from FIG. 10 that the lower maximum cutting handle forces are required across the range of wire rope diameters in the present disclosure tool.

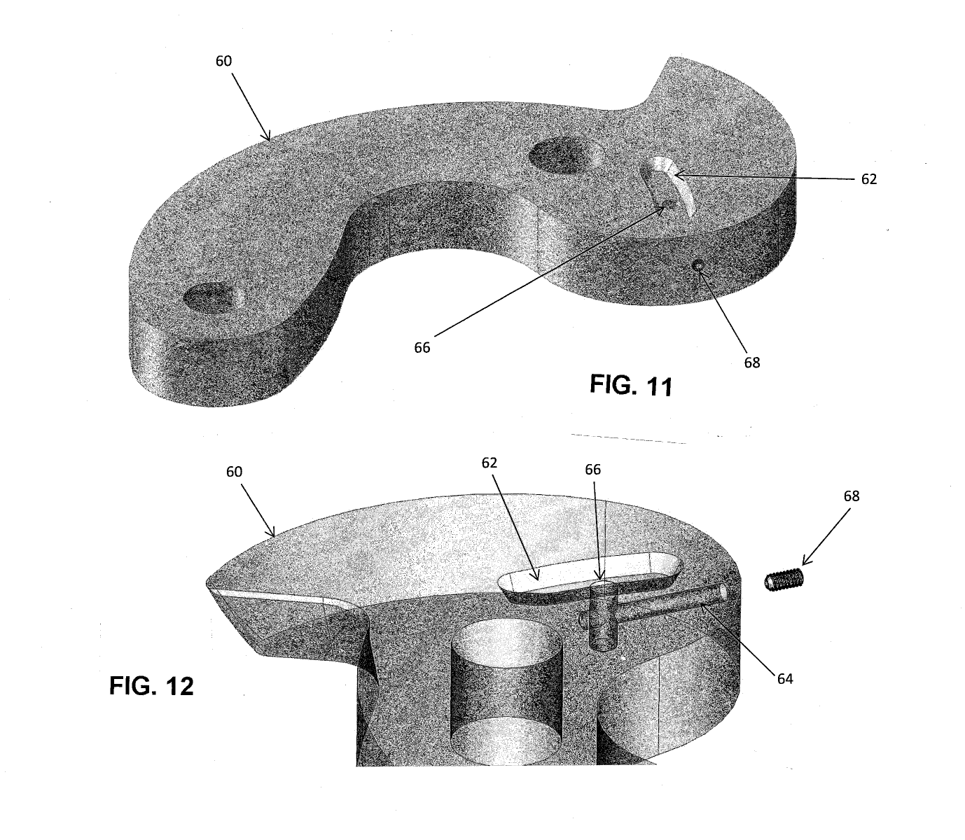

Referring now to FIGS. 11 and 12, the compound cutting feature of the present disclosure is improved with the addition of a lubricant film between the cutting jaws for purposes of reducing friction. With time, the grease can dissipate across wire rope cuts and travel outside the cutting jaws themselves. One option to relieve this concern is to require the customer to disassemble the compound section of the tool and reapply the lubricant film. The effort is more involved than the next mentioned alternative and is possibly prone to errors during reassembly.

In accordance with another aspect of the disclosure, as seen in FIGS. 11 and 12, a grease pocket or port 62 can be provided in and located between cutting jaw halves 60. A threaded grease insert channel 64 extends to a grease port 66 which in turn is connected to grease pocket 62. A threaded plug 68 is used to plug the channel 64.

The channel 64 can be refilled via a provided grease supply with a threaded connector without having to disassemble the compound jaw cutting section. While grease channels 64 and pockets 62 may exist to equipment, fasteners and other components, application to a cutting tool in such in the manner shown is unique.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the above description and the appended claims or the equivalents thereof.

1. A wire rope cutter, comprising:
a first handle and a second handle;
a first lever and a second lever;
a first cutting jaw and a second cutting jaw; wherein said first cutting jaw is formed at a distal end of said first lever;
said second cutting jaw is formed at a distal end of said second lever;
a first pivot for pivotally connecting said first handle and said second handle;
a second pivot for pivotally connecting said first lever to said first handle;
a third pivot for pivotally connecting said second lever to said second handle; and
a fourth pivot for pivotally connecting said first lever to said second lever.

2. The wire rope cutter of claim 1, wherein said first handle and said second handle each comprise a curved portion which are curved in opposite directions.

3. the wire rope cutter of claim 1, wherein said first lever comprises a first curved portion and a second curved portion which comprises said first cutting jaw.

4. The wire rope cutter of claim 3, wherein said second lever comprises a first curved portion and a second curved portion which comprises said second cutting jaw.

5. The wire rope cutter of claim 4, wherein said first curved portion and said second curved portion of said first lever each comprises an opening.

6. The wire rope cutter of claim 5, wherein said first curved portion and said second curved portion of said second lever each comprises an opening.

7. The wire rope cutter of claim 6, wherein one of said openings of said second curved portion of said first lever and one of said second openings of said second portion of said second lever align to receive a first pivot member.

8. The wire rope cutter of claim 7, wherein said first handle curved portion and said second handle curved portion each comprises a pair of openings.

9. The wire rope cutter of claim 8, wherein one of said openings of said first handle curved portion aligns with one of said openings of second handle curved portion to receive a second pivot member.

10. The wire rope cutter of claim 8, wherein one of said openings of said first lever aligns with one of said openings of said first handle curved portion to receive a third pivot member.

11. The wire rope cutter of claim 9, wherein one of said openings of said second lever aligns with one of said openings of said second handle curved portion to receive a fourth pivot member.

12. The wire rope cutter of claim 11, wherein a handle length is defined as the distance from an end of one of said handles and said first pivot.

13. The wire rope cutter of claim 12, wherein a pivot lever length is defined as a distance between said fourth pivot and one of said second and third pivots.

14. The wire rope cutter of claim 13, wherein a pivot jaw length is defined as the distance between said fourth pivot and an inner edge of one of said first and second cutting jaws.

15. The wire rope cutter of claim 14, wherein a pivot handle length is defined as the distance between said first pivot and one of said second and third pivots.

16. The wire rope cutter of claim 15, wherein a first mechanical advantage is defined as said pivot lever length divided by said pivot jaw length.

17. The wire rope cutter of claim 16, wherein a second mechanical advantage is defined as said handle length divided by said pivot handle length.

18. The wire rope cutter of claim 17, wherein a compound mechanical advantage is defined as said first mechanical advantage multiplied by said second mechanical advantage.

19. The wire rope cutter of claim 1, wherein at least one of said first cutting jaw and said second cutting jaw comprises a port for receiving a lubricant.

20. A compound wire rope cutter assembly, comprising:
a first handle and a second handle having a first pivot connecting said first and second handles;
a first cutting jaw half and a second cutting jaw half, wherein said first cutting jaw half is connected to said first handle via a second pivot;
wherein said second cutting jaw half is connected to said second handle via a third pivot; and
wherein said first cutting jaw half and said second cutting jaw half are connected by a fourth pivot; wherein a compound mechanical advantage is defined by a first mechanical advantage defined by a pivot lever length and a pivot jaw length, and a second mechanical advantage defined by a handle length and a pivot handle length.

21. The compound wire rope cutter of claim 20, wherein said handle length is defined as the distance from an end of one of said handles and said first pivot.

22. The compound wire rope cutter of claim 21, wherein said pivot lever length is defined as a distance between said fourth pivot and one of said second and third pivots.

23. The compound wire rope cutter of claim 22, wherein said pivot jaw length is defined as the distance between said fourth pivot and an inner edge of one of said first and second cutting jaw halves.

24. The compound wire rope cutter of claim 23, wherein said pivot handle length is defined as the distance between said first pivot and one of said second and third pivots.
